(19) United States
(12) Patent Application Publication
(10) Pub. No.: US 2018/0103240 A1
(43) Pub. Date: Apr. 12, 2018

(54) SMART SIGN SLEEVE

(71) Applicant: Rodney S Barnes, New York, NY (US)

(72) Inventor: Rodney S Barnes, New York, NY (US)

(21) Appl. No.: 15/291,542

(22) Filed: Oct. 12, 2016

(51) Int. Cl. H04N 7/18; G01V 8/12; G01P 13/00; H02S 20/30

(52) U.S. Cl. CPC H04N 7/188; G01V 8/12; E01F 9/688; H02S 20/30; G01P 13/00

(57) ABSTRACT

A solar powered Smart Sign Sleeve, that attaches to an existing stop sign or traffic sign post and uses motion sensors; lasers; cameras; hard drive; RF antenna; battery inversion pack and Wi-Fi to establish an approaching vehicle speed by sensors and upon detection, determine if the vehicle comes to a complete braking stop at the stop sign before proceeding through an intersection or making a turn. If vehicle does not come to a full stop, before proceeding pass the stop sign, the camera with an infra-red illuminator will photograph the vehicle license plate both day and night and transmit the vehicle violation by Wi-Fi or RF signal to a traffic bureau or agency, capable of dispensing fees and/or fines based on the documented time-stamped violation. The Smart Sign Sleeve, will also provide metrics to governmental agencies and other private related smart services data and analytics collection companies.

### CROSS-REFERENCE TO RELATED APPLICATIONS

NOT APPLICABLE

### BACKGROUND OF THE INVENTION

This application claims benefit of

### FIELD OF THE INVENTION

The present invention relates to traffic signs in general and to all stop signs in particular, that meet the requirements of traffic highway design and traffic highway intersection design, signing signaling to improve safety and traffic flow on streets, major thoroughfares, highways and intersections.

### BRIEF SUMMARY OF THE INVENTION

Stop signs are not typically powered by solar panels, or offer the ability of documenting a vehicle rolling through and/or not making a complete stop at the stop sign. This invention in particular, will aid in both the encouragement of obeying the traffic sign laws and documenting any violation because of failure to do the same; as the vehicle must come to a complete stop, calculated on speed, distance and time; or the embedded camera will capture the violation and transmit the infraction.

This invention requires no external power feeds or related street area power; because all power is generated from the solar panel that collects and stores energy through a charge controller into battery containment compartments that supplies power through an inverter to all functioning components; i.e., sensors, hard drives, cameras, laser and both antennas. The design of the smart sign sleeve allows for the retrofit of all existing MUTCD U-Channel compliant poles as referenced in the MUTCD Section 2A.06 “Design of Signs by utilizing the design of the sleeve to slide over existing MUTCD approved pole configurations.

Any existing street sign can be retrofitted by removing the existing sign panel face and sliding the integrated sleeve design over the pole and reattaching the sign panel face.

This invention creates a smart traffic sign that acts as a deterrent, because violators will receive a notice of infraction, a fine, or both. One of the most common traffic citations issued to drivers, is for the rolling stop default. When vehicles approach a stop sign, they are supposed to make a clear stop. However, some people may be in a rush or may be tempted to only slow down at the sign and not fully stop. In most states, drivers are required to make a complete stop at stop signs. This means that the vehicle needs to stop at the limit line. If there is no limit line, then the vehicle needs to stop at the intersection's entrance. Slowly rolling through the intersection or pausing is in violation of the law and this can pose a danger to other drivers as well as pedestrians.

### BRIEF DESCRIPTION OF THE SEVERAL VIEWS OF THE DRAWINGS

FIG. 1 is a front elevation view of a traffic sign modifications made in accordance with the present smart sign sleeve invention with the attached pivotal solar panel and front speed sensor.

FIG. 2 is a rear/side elevation view of the modified traffic sign made in accordance with the present invention.

FIG. 3 is an elevation view of the compartments showing the interior components made in accordance with the present invention.

FIG. 4 is a schematic diagram of the components used in accordance with the present invention.

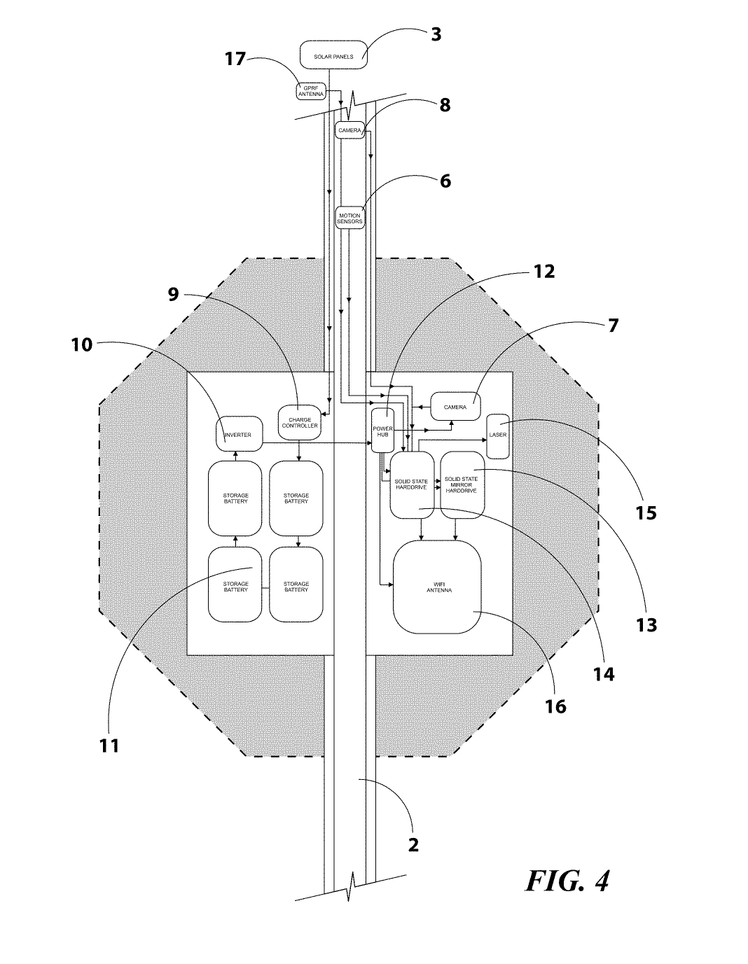

FIG. 5 is a geographical aerial view of the smart traffic sign identifying an approaching vehicle in accordance with the present invention.

FIGS. 6A, 6B and 6C illustrate the transmission of information to a municipal or traffic control office through a relay antenna, in accordance with the present invention, by using either a Wi-Fi hotspot or RF signal relay.

### DETAILED DESCRIPTION OF THE INVENTION

The present invention will now be described using a STOP sign for illustrative purposes only and that a person skilled in the art will understand that the present invention can be used with all traffic signs referenced in the MUTCD Section 2A.06 “Design of Signs.

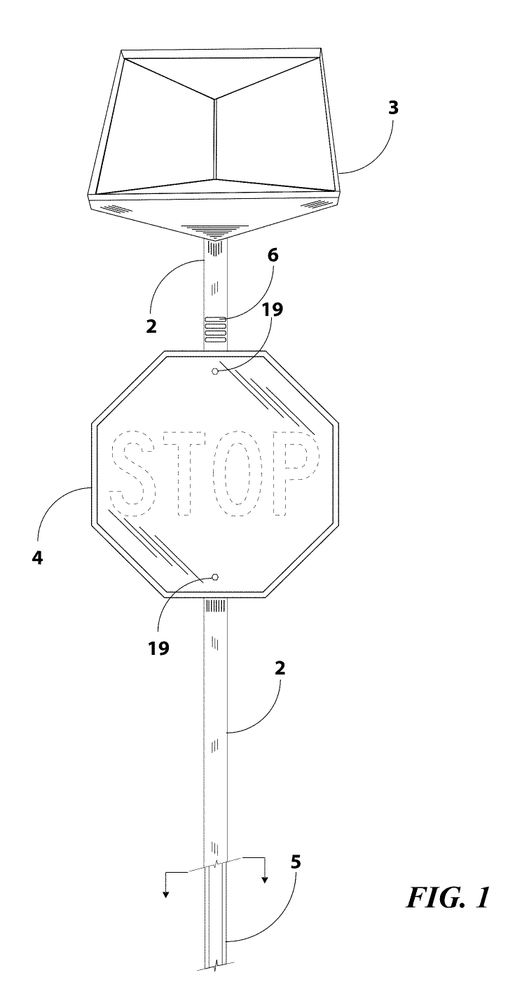

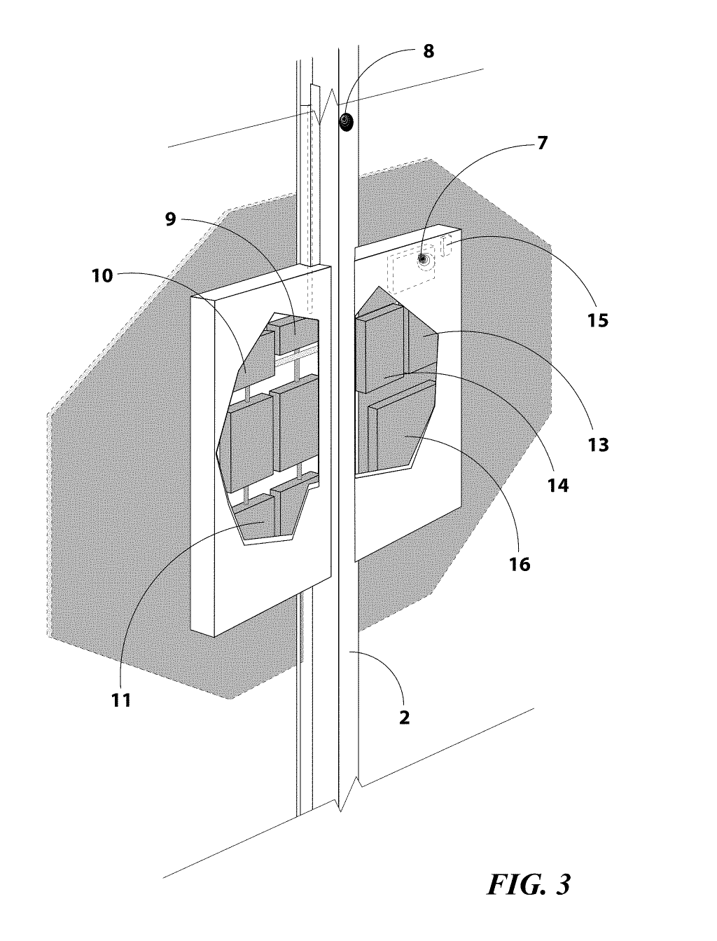

A smart sign sleeve made in accordance with the present invention is disclosed in FIG. 1. The smart sign sleeve includes an HDPE rigid and abrasion resistant sleeve that slides over and covers an existing traffic sign post 4, which is properly anchored in the ground. The existing post 5 is preferably a hollow MUTCD U-Channel style as to function as a raceway for the electrical conductors from the solar panel 3 that power the smart sign sleeve 12, FIG. 3.

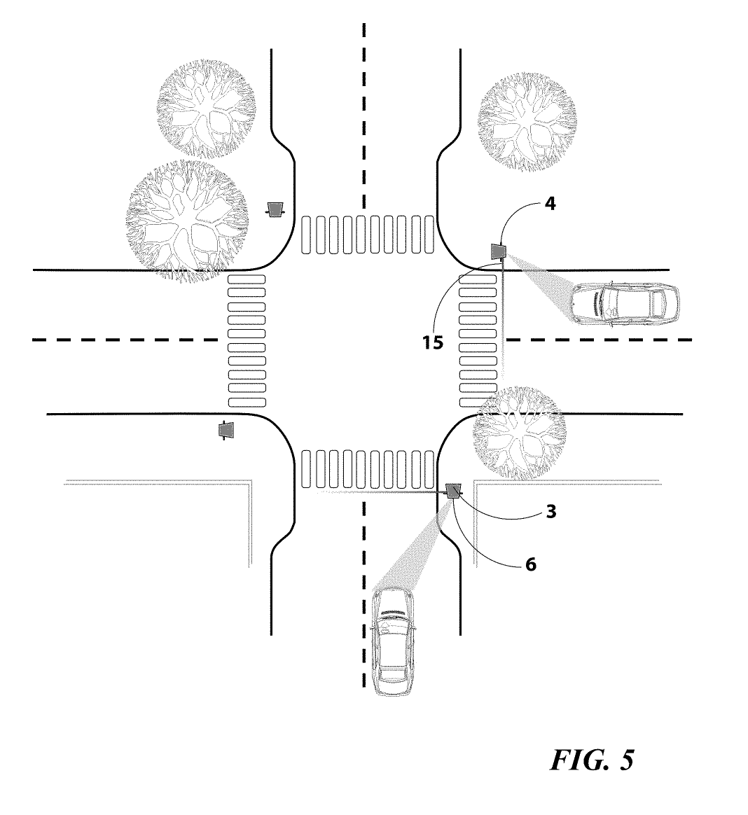

The smart sign sleeve includes a front motion sensor 6 capable of detecting approaching vehicles as best shown in FIG. 5. The front sensor 6 is embedded into the HDPE smart sign sleeve 2 and may incorporate a protective surface or shield, to protect the sensor 6 from the detrimental or disabling effects of the environment caused by pollutants, rain, snow, ice or UV rays.

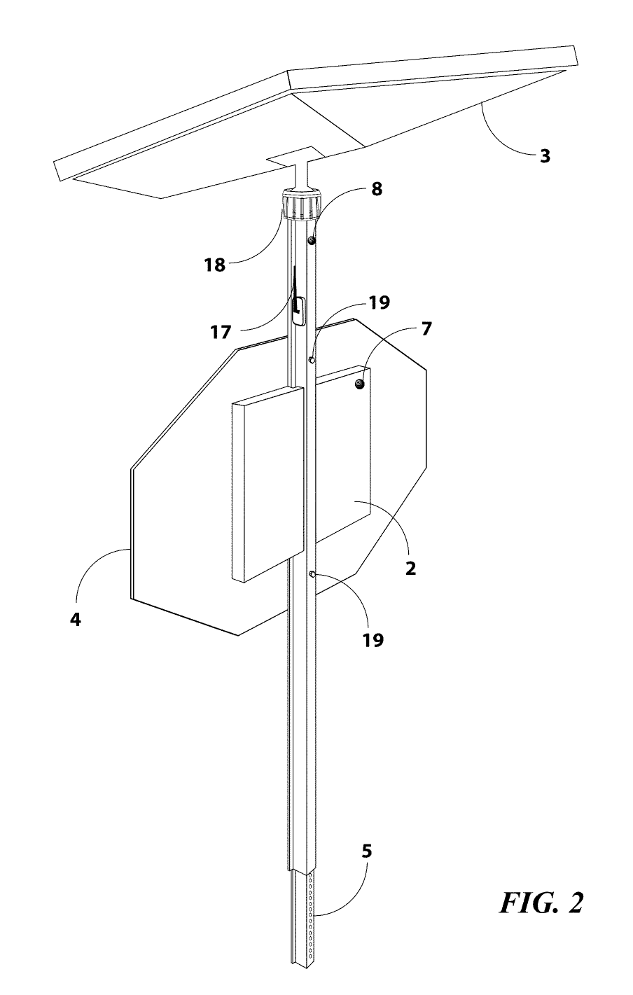

The smart sign sleeve is made from HDPE that is stabilized for UV radiation and provides support for a top mounted pivoting solar panel 3 and traffic sign face 4, as best shown in FIGS. 2 and 5. The traffic sign face 4 may be attached to the smart sign sleeve 2 using mounting means, such as tamper-proof nuts or bolts made of stainless steel 19. The smart sign sleeve 2 also contains numerous electronic, optical and communication devices in the smart sleeve construction, as best shown in FIG. 3.

The smart sleeve contains a front facing sensor 6 to detect approaching vehicles and engage the solid state hard drive's 14 calculating sequence based on distance and the established speed limit to determine if the approaching vehicle allows enough me to elapse before proceeding past the laser sensor 15. If the laser sensor 15 is activated prior the necessary time lapse, the laser sensor will relay a signal to the solid state hard drive 14 to activate the rear encased camera 7 to capture a photo of the offending vehicle's rear license plate. The camera 7 will also contain an infra-red illuminator to capture photos during evening and nighttime hours or in situations where normal sunlight is diminished.

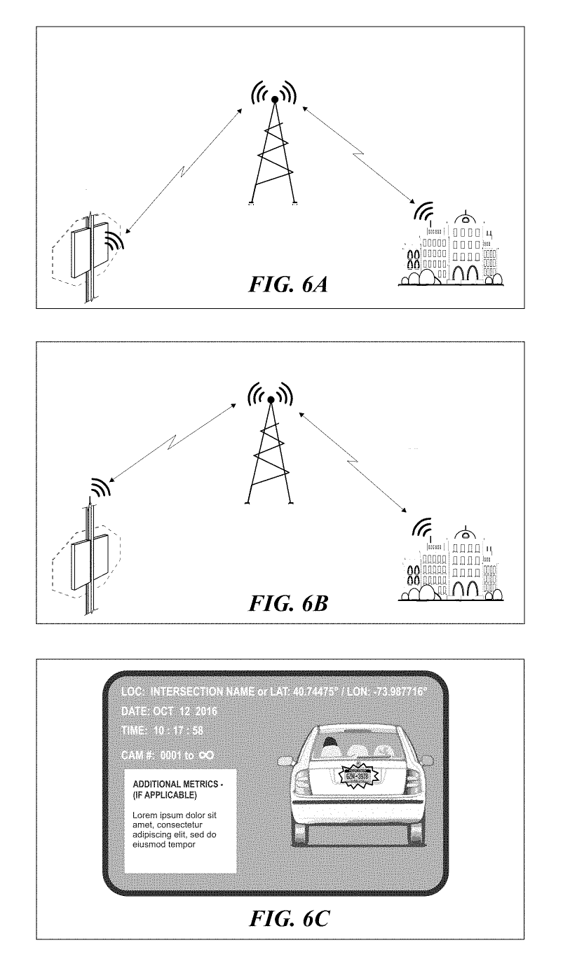

The photo of the infraction and/or violation is catalogued on the solid state hard drive 14 and transmitted by either a Wi-Fi antenna 16 or a RF antenna 9 to the local governmental or traffic monitoring agency, as shown in FIGS. 6A 6B and 6C.

The power hub 12 for all components distributes electricity generated by the capture and conversion of solar energy through the use of a photovoltaic panel array 3, which is mounted on top of the smart sign sleeve 2 to capture sunlight and distribute the energy to the charge controller 9 and surplus battery storage compartments 11. The photovoltaic panel array 3 will generate electricity directly from sunlight to power the electrical devices encased in the smart sign sleeve 2 by use of a solar inverter 10, to change the electrical current from DC to AC. The battery compartments 11 will store a surplus for later use, or when needed and can recharge during periods of low demand.

Monitoring of the photovoltaic system can be performed on site or remotely, to measure power levels, retrieve data from the solar inverter 10 or retrieve all of the data from the solid state hard drive 14 by use of the Wi-Fi antenna 16 or RF antenna 17 communicating equipment.

The solar panel 3 as best shown in FIG. 2 can be positioned or aimed directly at the sun or where the greatest amount of sunlight capture can occur with the use of the adjustable pivot mount 18. Referring to FIGS. 2 and 3, all of the electric and electronic components required for the operation of the smart sign sleeve, are self-contained and encased within the HDPE sleeve design. The smart sign sleeve 2 is easily installed or removed by first removing an existing traffic sign face mounting hardware 19 along with the traffic sign face 4. Once removed, the smart sign sleeve 2 easily lowers on or raises off an existing traffic sign post 5. Once in place or removed, the traffic sign face 4 along with the existing mounting hardware 19 can be reinstalled to its original or upgraded smart sign condition.

This invention has be described as having a preferred design, however it is understood that the preferred design could receive further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

I claim:

1. A Smart Sign Sleeve, comprising:
a) an existing traffic sign panel and post;
b) a HDPE rigid sleeve that slides on an existing traffic sign post;
c) a positionable photovoltaic panel array energy collection source operably connected to said HDPE sleeve to capture and convert solar energy to inverted power for operation; with
d) said sensor, hard drive and laser that is activated by an approaching vehicle; and
e) computes the lapsed me between the time of motion sensor activation and making contact with the laser beam, based on the posted speed and the distance to the laser beam, to
f) determine if the approaching vehicle prematurely breaks said laser beam before the designated time expiration, which establishes failure to make a complete vehicular stop as required by law.

2. A smart sign sleeve as in claim 1, wherein said sleeve is used with an existing traffic sign.

3. A smart sign sleeve as in claim 1, wherein said sign is made of high-density polyethylene (HDPE) plastic.

4. A smart sign sleeve as in claim 1, wherein said HDPE sleeve is attached to a pivotable photovoltaic panel.

5. A smart sign sleeve as in claim 3, wherein said sleeve contains a charge controller, battery storage and a power inverter in one compartment.

6. A smart sign sleeve as in claim 3, wherein said sleeve contains a power hub, hard drives, cameras, class 1 laser and Wi-Fi and RF antennas in one compartment.

7. A smart sign sleeve as in claim 4, wherein the photovoltaic panel provides solar energy that is stored in internal batteries.

8. A smart sign sleeve as in claim 5, wherein the internal batteries provide inverted power to the power hub.

9. A smart sign sleeve as in claim 6, wherein the internal batteries provide inverted power to the power hub.

10. A smart sign sleeve as in claim 6, wherein the power hub supplies power to the sensor, laser, hard drives, cameras and both Wi-Fi and RF antennas.

11. A smart sign sleeve as in claim 1, wherein the sensor, hard drives and laser are activated by moon.

12. A smart sign sleeve as in claim 1, wherein the sensor activates the timing sequence contained on the hard drive.

13. A smart sign sleeve as in claim 1, wherein the timing sequence determines if adequate me has elapsed and/or expired prior to passing the laser sensor.

14. A smart sign sleeve as in claim 1, wherein if adequate time has not elapsed, the camera is turned on to photograph the offending vehicular license plate.

15. A smart sign sleeve as in claim 1, is attached to an existing pole with tamper-proof fasteners.
